(19) United States
(12) Patent Application Publication
(10) Pub. No.: US 2015/0060272 A1
(43) Pub. Date: Mar. 5, 2015

(54) AMPEROMETRIC DETECTION OF LIMULUS AMEBOCYTE LYSATE ACTIVATION BY ENDOTOXIN AND/OR 1-3-BETA-D-GLUCAN

(71) Applicant: Nanomix, Inc., Emeryville, CA (US)

(72) Inventors: Richard Andrew Blidner, Benicia, CA (US); Albert Gutes-Regidor, El Cerrito, CA (US); Ray R. Radtkey, Oakland, CA (US)

(21) Appl. No.: 14/542,196

(22) Filed: Nov. 14, 2014

Related U.S. Application Data
(63) Continuation-in-part of application No. 13/844,334, filed on Mar. 15, 2013.
(60) Provisional application No. 61/905,066, filed on Nov. 15, 2013.
(60) Provisional application No. 62/011,518, filed on Jun. 12, 2014.

(51) Int. Cl. G01N 27/327

(52) U.S. Cl. CPC G01N 27/3271
USPC 204/403.05; 204/403.01; 204/403.14; 204/403.04

(57) ABSTRACT

Devices to detect detecting endotoxin (lipopolysaccharide or LPS) and/or 1-3-β-D-glucan (beta glucan or BG) using substrates including electrogenic mediators for amperometric detection are provided herein. Substrates include an amine group as well as one or more substituted organic rings, such as a phenol. Devices include cartridges for detecting LPS or BG simultaneously using dual detection techniques.

### CROSS-REFERENCE TO RELATED APPLICATION

This application claims benefit of U.S. Provisional Patent Application No. 61/905,066, filed 15 Nov. 2013, and titled “AMPEROMETRIC DETECTION OF LIMULUS AMEBOCYTE LYSATE ACTIVATION BY ENDOTOXIN AND/OR 1-3-BETA-D-GLUCAN,” and U.S. Provisional Patent Application No. 62/011,518, filed 12 Jun. 2014, and titled “AMPEROMETRIC DETECTION OF LIMULUS AMEBOCYTE LYSATE ACTIVATION BY ENDOTOXIN AND/OR 1-3-BETA-D-GLUCAN,” which are herein incorporated by reference in their entireties and for all purposes. This application is a continuation in part of U.S. patent application Ser. No. 13/844,334, filed 15 Mar. 2013, and titled “POINT OF CARE SENSOR SYSTEMS,” which is herein incorporated by reference in its entirety and for all purposes.

### BACKGROUND

1. Technical Field

The disclosed embodiments involve amperometric detection methods, substrates, and apparatuses for point-of-use testing of Limulus Amebocyte Lysate-activated compounds such as endotoxins and/or 1-3-β-D-glucan.

2. Description of Related Art

Testing processes and devices for contamination and clinical procedures are important to various industries today. Industrial testing processes are also often used to verify the elimination of pyrogens and decontamination injectable pharmaceuticals, medical devices, water and food resources, disposables, and other products. For example, a needle manufacturer may test products for contamination during the manufacture process to ensure a sterile product complies with various regulations. Industrial tests may be performed by obtaining a liquid sample from the product, such as by using specific solvents. For clinical applications, in vitro diagnostic (IVD) tests are increasingly being used in modern health care. These tests are performed using devices analyzing specimens drawn from patients. Blood, plasma, serum, urine, and tissue specimens can be derived from a patient to identify information regarding a physiological or pathological state.

Conventional methods of testing for endotoxin (lipopolysaccharide) or 1-3-β-D-glucan have used limulus amebocyte lysate techniques, such as gel clot, colorimetric, or fluorogenic methods. Point-of-use processes of conventional industrial and clinical equipment in such contexts are limited.

### SUMMARY

Substrates and devices for detecting presence of endotoxins and/or 1-3-β-D-glucan are provided. One aspect involves an electrochemical substrate for detecting endotoxins and/or 1-3-β-D-glucan, the substrate including: a peptide, and an electrochemical group selected from one of the following structures:

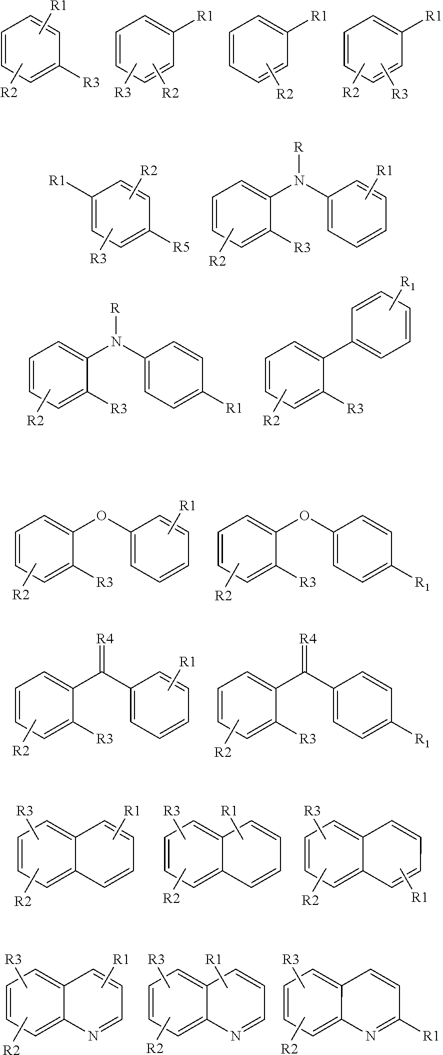

such that R1 is a primary amine, or a secondary amine, R2 is a hydroxyl, a methoxy, an ether, ketone, an aldehyde, or a carboxylic acid, R3 is a hydrogen, halide, or hydroxyl, R4 is a hydrogen or hydrocarbon chain R is a hydrogen or hydrocarbon chain, and R5 is a methoxy, an ether, a ketone, an aldehyde, or a carboxylic acid.

In some embodiments, R1 is capable of conjugating to a C-terminus of the peptide. In some embodiments, the substrate is reactive to an activated clotting enzyme of limulus amebocyte lysate. In various embodiments, the substrate has one or more detectable oxidation or reduction peaks between about −300 mV to about 300 mV. In some embodiments, the peptide includes a sequence A1-A2-Aₙ, where n is an integer greater than or equal to 3. In various embodiments, the amino acid residues are bonded to the electrochemical group via the C-terminus of Aₙ. In some embodiments, Aₙ is arginine.

Another aspect involves a cartridge for sensing one or more analytes in a sample including one or more sample inlet chambers; one or more electrochemical sensors; one or more solid phase limulus amebocyte lysate detection reagents; and one or more detection channels providing a flow path over the one or more electrochemical sensors.

In some embodiments, the cartridge further includes a reagent chamber configured to store the one or more solid phase limulus amebocyte lysate detection reagents. The cartridge may also include a mixing circuit connected to the one or more sample inlet chambers and including a mixing chamber and the reagent chamber.

In some embodiments, the cartridge also includes a de-bubbling channel disposed upstream of the one or more detection channels and configured to vent out bubbles in the sample. The cartridge may also include at least two electrochemical sensors and may be configured to detect endotoxins and beta-glucans from a single sample.

In some embodiments, the cartridge further includes a heater configured to heat the one or more detection channels. The heater may be formed by a technique selected from the group consisting of screen-printing, photolithography, sputtering, and ink jet. In some embodiments, the cartridge also includes a thermocouple.

In various embodiments, the cartridge includes a microfluidic layer which may include the reagent chamber, the mixing chamber, and the one or more detection channels. In some embodiments, a plurality of fluid stops connected to a hydrophobic membrane.

In some embodiments, all liquid movement within the cartridge is pneumatically actuated. In various embodiments, liquid in the cartridge is moved by capillary action.

The cartridge may also include pneumatically actuated valves for controlling fluid movement in the cartridge. The cartridge may also include an immunoassay detection chamber.

These and other aspects are described further below with reference to the drawings.

### BRIEF DESCRIPTION OF THE DRAWINGS

FIG. 1A is a diagram of a Limulus Amebocyte Lysate (LAL) cascade for endotoxin and 1-3-β-D-glucan.

FIG. 1B is a diagram of a LAL cascade for endotoxin using recombinant Factor C.

FIGS. 2A-2R are example structures of mediators in disclosed embodiments.

FIG. 3A is an example process flow for electrochemical LAL assays that may be implemented using systems and substrates described herein.

FIGS. 3B, 3C, and 3E are examples of cartridge block diagrams for sample filtering, mixing in an LAL chamber, and analysis.

FIG. 3D is an example arrangement of electrodes for assays and controls according to various embodiments.

FIG. 4 is an example of a simplified schematic showing an example of a point-of-use system, including a reader and a cartridge that can be inserted into the reader.

FIG. 5A is an example of a schematic representation of an exploded view of a cartridge, in accordance with disclosed embodiments.

FIG. 5B is an example of schematic representations of micro-fluidic layers of a cartridge.

FIGS. 6A and 6B are schematic drawings of examples of diaphragm valves that may be used in accordance with disclosed embodiments.

FIG. 7 is a schematic illustration of an example of a sensing assembly in accordance with disclosed embodiments.

FIGS. 8A and 8B are plots of experimental results for detecting bound versus free mediators in accordance with disclosed embodiments.

FIG. 9 is a plot of experimental results for detecting a range of a mediator in accordance with disclosed embodiments.

FIG. 10A is a plot of experimental results for amperometric detection of 1-3-β-D-glucan in accordance with disclosed embodiments.

FIG. 10B is a plot of experimental results for amperometric detection of endotoxin in accordance with disclosed embodiments.

### DETAILED DESCRIPTION

In the following description, numerous specific details are set forth to provide a thorough understanding of the presented embodiments. The disclosed embodiments may be practiced without some or all of these specific details. In other instances, well-known process operations have not been described in detail to not unnecessarily obscure the disclosed embodiments. While the disclosed embodiments will be described in conjunction with the specific embodiments, it will be understood that it is not intended to limit the disclosed embodiments.

Point-of-use testing is performed at or near the site of testing. The driving notion behind this approach is to bring the test conveniently and immediately to a user. This increases the likelihood that user receive results quicker and make more immediate decisions. Point-of-use testing may be accomplished using portable instruments and/or test kits. Small bench analyzers or other fixed equipment are often used because portable devices are not available for many types of tests. The goal of point-of-use testing is to collect samples and obtain results quickly at or near the location of the tested subject, such as a patient in clinical settings, or a product or liquid sample in industrial settings, so that a plan to remedy any infection or contamination may be implemented immediately. In some clinical settings, point-of-use testing instruments can allow for more rapid decision making and triage, reduce operating times, reduce high-dependency postoperative care time, reduce emergency room time, reduce the number of outpatient clinic visits, reduce the number of hospital beds used, and ensure optimal use of professional time. In some industrial settings, point-of-use testing instruments allow for rapid feedback to improve efficiency in a manufacture line, test many samples in using a convenient device in the field, and ensure compliance with quality control regulations.

The portable instruments described herein for point-of-use testing and industrial applications are relatively simple to accommodate a wide range of medical professionals, non-professional administrators, manufacturing/QC personnel, and even patients. They are sufficiently robust and can withstand transportation, changes in temperatures, mechanical stresses, and other environmental impacts typically associated with portable devices. For example, in some implementations, the portable point-of-use testing instruments described herein may be used in moving emergency vehicles (such, as ambulances, helicopters), military missions, and other like environments. Additionally, in some implementations, a variety of tests are supported by one portable instrument. This can be advantageous as many point-of-use environments cannot support multiple instruments. In some implementations, the portable point-of-use testing instruments are configured to provide fast responses and perform multiple parallel tests on a single sample. The systems also provide precise measurement in a cost-effective manner. In some implementations, the systems provided herein allow for point-of-use assays that are stable at room temperature and have high sensitivity. The systems can provide the same or better performance as plate-reader systems using refrigerated liquid reagents.

Detection of microbial contamination is important to various industrial and clinical applications. Contamination by certain types of bacteria and fungi, including yeasts and molds, may cause illness and even death. Various regulations govern processes and products in the food and beverage industry, in water departments, and in the pharmaceutical and medical device industries with specific standards used to confirm that products are safe for consumers and are free of contamination. Examples of standards-setting bodies include the United States Pharmacopeia (USP), United States Food and Drug Administration (USFDA), and the Environmental Protection Agency (EPA). The methods and devices disclosed herein may meet and be used to comply with such standards.

Methods and devices herein are suitable for detecting bacterial endotoxins; 1-3-β-D-glucan, a type of beta glucan (BG); and/or other Limulus Amebocyte Lysate-reactive compounds for point-of-use testing. Endotoxins, or lipopolysaccharide (LPS), are embedded in the cell membrane of Gram negative bacteria, which are important in the development of sepsis, or septicemia. 1-3-β-D-glucan is a compound found in cell membranes of fungi and yeasts.

The presence of LPS or BG activates a clotting enzyme in amebocytes (blood cells) of the horseshoe crab, Limulus polyphemus. The Limulus Amebocyte Lysate (LAL) obtained from these amebocytes includes the clotting enzyme and other various proteins involved in the LAL cascade.

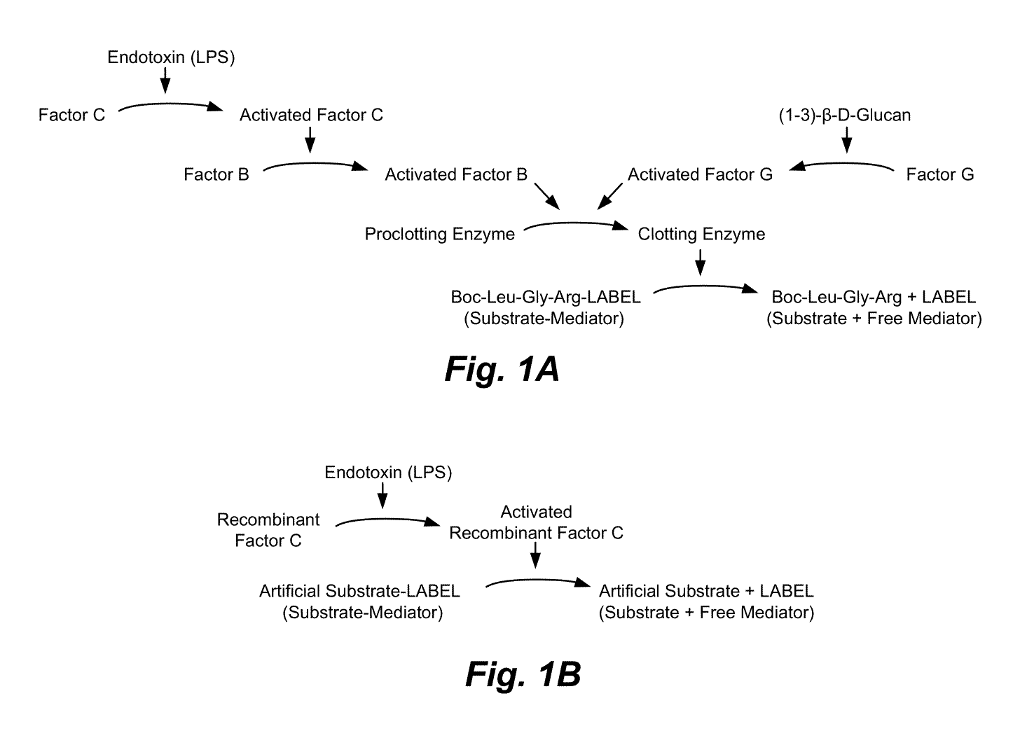

FIG. 1A provides a schematic depiction of the LAL cascade. In the presence of LPS or BG, the LAL cascade results in the activation of a clotting enzyme protease that is capable of cleaving a conjugated label from an artificial substrate. Endotoxin or LPS activates Factor C to form an activated Factor C. Subsequently, the activated Factor C activates Factor B, forming activated Factor B. The activated Factor B then activates the proclotting enzyme to form a clotting enzyme. The clotting enzyme may then be used in subsequent processing, such as via a reaction with a substrate or a coagulogen, to form a detectable compound, which may include a released label. As shown in FIG. 1A, BG activates Factor G, forming activated Factor G. Activated Factor G also converts the proclotting enzyme to the clotting enzyme. Thus, both LPS and BG may be detected in LAL testing via the LAL cascade. The amount of activated clotting enzyme is proportional to the initial concentration of LPS and/or BG in the sample, and the amount of detectable compound such as a label is proportional to the amount of activated clotting enzyme. Through these proportional relationships, the detection of the amount of detectable compound provides a means to quantitatively determine the amount of LPS and/or BG in a sample.

FIG. 1B shows a schematic depiction of an LAL cascade where a recombinant Factor C enzyme is used. A recombinant Factor C enzyme can be used without the other cascade components. That is, once recombinant Factor C is activated by LPS, a substrate that is reactive to the activated recombinant Factor C may release a label that is detected using amperometric methods.

Since recombinant Factor C is only activated by LPS and not BG, LAL reagents including recombinant Factor C can be used to detect only the presence of LPS in a sample that my include both LPS and BG. As described below, substrates and cartridges described herein may be used to detect only LPS, only BG, or both. In some embodiments, assays are capable of distinguishing between detection of LPS and BG. Alternatively, the Factor G pathway can be blocked by the addition of one or more interfering substances to the Factor G pathway.

Conventional methods for testing LPS involve turbometric, chromogenic, or fluorogenic detection. In a turbometric method, the optical density is measured as a result of the clotting reaction. In a chromogenic method, the clotting enzyme reacts with an artificial substrate to produce a chromophore that can be detected. Convention substrates use p-Nitroaniline (pNA) as a label but such substrates may not be suited for point-of-use or rapid testing applications. In a fluorogenic method, the clotting enzyme or recombinant Factor C reacts with an artificial substrate to produce a fluorophore that can be detected.

Conventional methods of turbometric, chromogenic, and fluorogenic methods are not suitable for testing samples that are not compatible with optical detection methods. For example, some conventional methods may only be capable of processing optically transparent samples and not capable of processing opaque samples.

Provided herein are substrates and devices for point-of-use and rapid LAL testing for LPS and BG using amperometric detection. Electrochemical or amperometric detection is capable of testing samples regardless of opacity. As used herein, the term “substrate” is defined as a compound reactive to the LAL clotting enzyme. Suitable substrates described herein include mediators with an electrochemical label, such that a free or unbound mediator may be detected using amperometric detection.

Mediators

A mediator may be detectable at an offset voltage range such that there is not substantial interference with other compounds that may be present, such as compounds in a sample. Further, the mediator may be distinguished between its bound state (mediator bound to a peptide, polymer, or compound) and its free state (free mediator, as shown in FIG. 1A). The term “mediator” or “label” is defined as a compound that, when bound, is a part of a substrate and may not exhibit electrogenic activity, but when free, is detectable by electrochemical and amperometric techniques and may exhibit a charge or current. A “free mediator” as used herein is a mediator that is not bound to the substrate. The lower the oxidation or reduction potentials are to detect the substrate, the less restrictive it may be to be used in more complex systems.

The substrate may be reactive to one or more LAL proteases. For example, the substrate may be reactive to the LAL clotting enzyme. In some embodiments, some substrates may be used that are only reactive with an activated recombinant Factor C enzyme to detect LPS. In various embodiments, substrates include a C-terminus.

In some embodiments, the substrate includes PG-A1-A2-/-Aₙ-M, wherein n is an integer greater than or equal to 3, and the substrate may include n amino acid residues in the peptide sequence. PG represents a protecting group used to cap the N-terminal for stability and may not be functional in protease recognition of the substrate. In various embodiments, Aₙ, or the last amino acid residue of the substrate that binds to the mediator, is arginine. In some embodiments, Aₙ₋₁, or the amino acid residue bonded to the last amino acid residue on the substrate, is glycine, cysteine, alanine, or glutamine.

In some embodiments, the substrate includes Boc-A1-A2-A3-M, where M is the mediator. A1, A2, and A3 may be amino acid residues of a peptide. For example, A1 may be leucine, A2 may be glycine, and A3 may be arginine. For substrates that may be recognized by an activated recombinant Factor C protease, A1 may be valine, A2 may be proline, and A3 may be arginine (Val-Pro-Arg-M), or A1 may be asparagine benzyl ester, A2 may be proline, and A3 may be arginine (Asp(OBzl)-Pro-Arg-M). One application for the embodiments described herein is the simultaneous electrochemical detection of BG and LPS in biological samples for sepsis diagnostics. Substrates, devices, and methods described herein are able to differentiate between invasive fungal infections and bacterial infections as the cause of sepsis. In some embodiments, the product may be integrated with an immunoassay cartridge. In addition to sepsis diagnosis, general LPS and BG contamination detection may be performed. Embodiments described herein may also be used to detect LPS in industrial samples, such as when testing injectable pharmaceutical products, medical devices, or water and food quality. Detection time for BG and LPS may be performed in less than about 15 minutes in some cases, and no more than about 60 minutes.

Mediators as described herein include at least one amine, for conjugation to a C-terminus of any suitable artificial substrate for the activated clotting enzyme of LAL. Any appropriate substrate may be used with the mediators described herein. Suitable substrates in disclosed embodiments are not limited to the examples described. In various embodiments, the mediator is bonded to the substrate by an amide bond to the C-terminus of the substrate. In some embodiments, the bond between the mediator and the substrate is a peptide bond. In various embodiments, mediators have detectable oxidation or reduction peaks between about −300 mV and about 300 mV, or between about −200 mV and about 200 mV, or between about −100 mV and about 100 mV. In some embodiments, the mediators have detectable oxidation or reduction peaks in a range of 0 to 300 mV or 0 to 200 mV. In some embodiments, the mediators have detectable oxidation or reduction peaks in a range of −300 to 0 mV or −200 to 0 mV. Oxidation or reduction peaks in the described ranges may be measured vs. Ag/AgCl reference electrode. The oxidation and reduction peaks of a mediator bound to a substrate as described herein (or a “conjugated substrate”) are shifted from those of the unconjugated free mediators.

The structure of the mediator includes at least one amine, and at least one substituted organic ring structure. Amines may be a primary amine, secondary amine, or a heterocyclic amine. The organic ring structure may include an amine in some embodiments, such as in a heterocyclic amine. In some embodiments, the organic ring structure includes at least one phenyl ring, or a phenol. In some embodiments, where there is more than one organic ring structures, the mediator may have only one ring that is substituted, while the other ring(s) is or are not substituted. In some embodiments, the mediator includes two rings, which may be bonded via a chemical bond, or may share a bond, or may be connected by a chain, such as a hydrocarbon chain. The substituents on the substituted organic ring structure may include an oxygen-containing functional group. Example functional groups that are bonded to the organic ring of a mediator as described herein include hydroxyls, methoxys, ethers, ketones, and carboxylic acids.

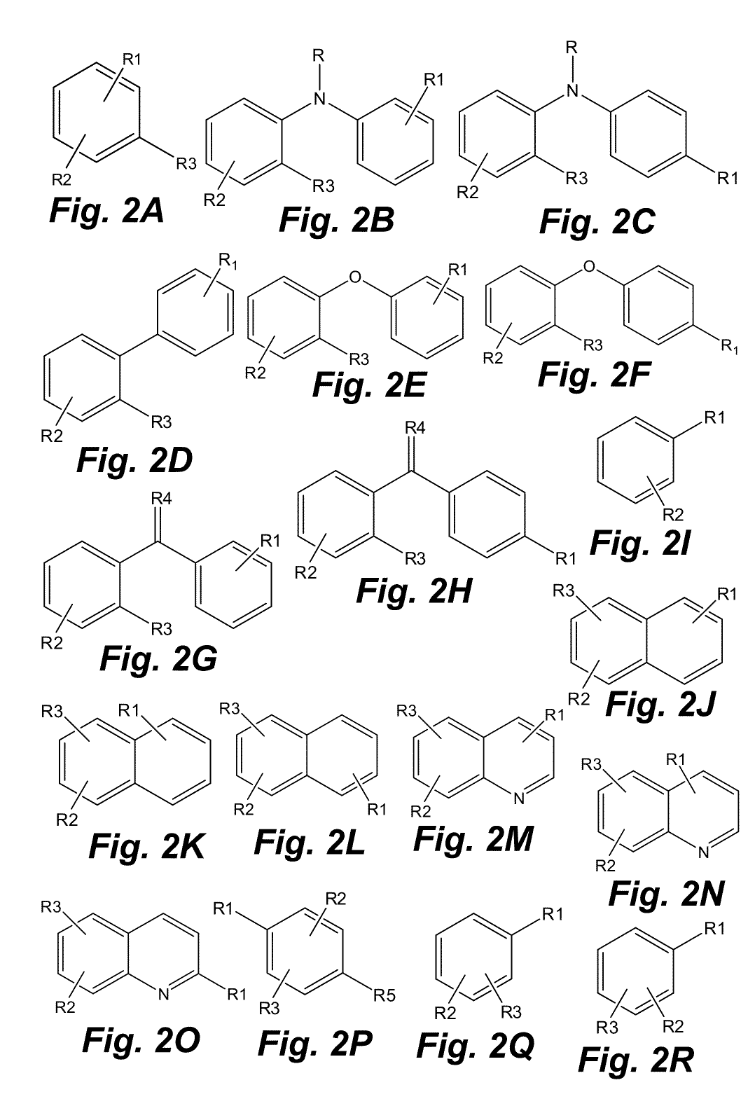

FIGS. 2A-2R provide example mediator structures, with corresponding R1, R2, R3, R4, R, and R5 groups. In each figure, R1 may be a primary amine, secondary amine, or if there is a suitable peptide group on the substrate, a hydroxyl or carboxylic acid group. R2 may be a hydroxyl group, a methoxy group, an ether group, a ketone group, an aldehyde, or a carboxylic acid. R3 may be optional and may be an electronegative substituent, such as a halide (chlorine, fluorine, iodine, for example), or a hydroxyl group. In some embodiments, R3 is a hydrogen. R4 may be a hydrogen or a hydrocarbon chain. In some embodiments, R may be a hydrogen or a hydrocarbon chain. R5 may be a methoxy group, an ether group, a ketone group, an aldehyde, or a carboxylic acid.

In some embodiments, the mediator includes a phenol and an amine group. In some embodiments, a phenol includes an amine substituent and an electronegative substituent. In some embodiments, two aromatic rings are bonded via an amine, with amine and methoxy substituents. Specific examples of mediators include p-aminophenol, 4-amino-2-chlorophenol, and 4-amino-4′methoxydiphenylamine:

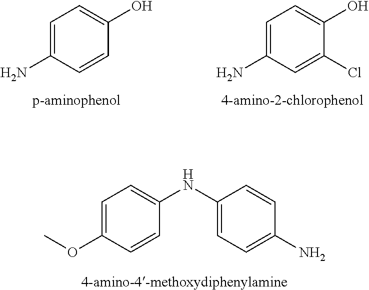 [SMILES: Nc1ccc(O)cc1 ; Nc1ccc(O)c(Cl)c1 ; COc1ccc(Nc2ccc(N)cc2)cc1]

In some implementations, the artificial substrate may be bound to a label by an amide bond. When an enzyme such as the clotting enzyme of LAL degrades the substrate, the amide bond may be cleaved such that a free mediator or label is released. In contrast to the bound product, which does not have electrogenic activity, the free mediator may exhibit electrogenic activity. For example, in some amperometric techniques, a potential may be held constant while a current is measured such that if the current is correlated to the concentration of free mediator present. A bound product may not exhibit a current in some implementations. Therefore, the bound product and the free mediator have different electrical properties, thereby enabling them to be used in amperometric detection.

In some implementations, the label may have a means for conjugation to the C-terminus of any artificial substrate. For example, the artificial substrate may be a peptide sequence such that an amide is formed when bonded to a primary amine group of a mediator. The amide group may be cleaved by an activated enzyme, releasing the differentially detectable free mediator.

CARTRIDGES

Aspects described herein include cartridges suitable to detect LPS and BG using a reader or other suitable instrument. A cartridge may include a housing, which includes fluid inlet ports, fluid conduits, fluid pumps, fluid stops, sensors, at least one heater, and reagents. In some embodiments, the reagents are stored in a reagent channel, or in the sensor well, or are localized within fluid conduits. In some embodiments, the reagents are stored in an in-channel glass fiber matrix in the sensor well. The cartridge may have a microfluidic structure, as described below. Optionally, the cartridge may include a pump or mixing circuit, and/or a debubbler. Cartridges used herein are not contaminated with endotoxins (e.g., they are endotoxin-free). In some embodiments, cartridges are made of plastic or include components such as a glass or insoluble polymer matrix for reagent storage. Cartridges may be made endotoxin-free by baking at a high temperature, such as greater than about 250° C., to remove any endotoxins. Other common cleaning methods for eliminating endotoxins may be used as well. In some embodiments, the cartridge is configured to comply with USP (U.S. Pharmacopeia) regulations.

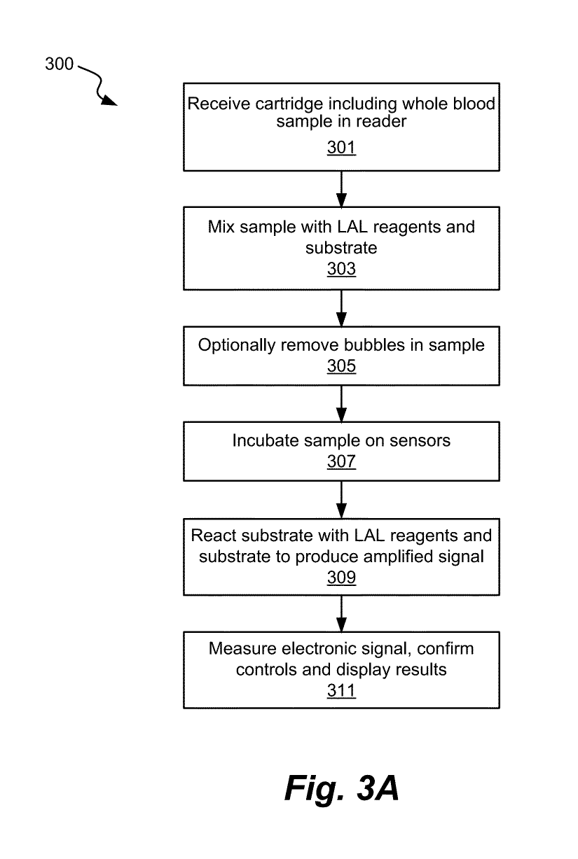

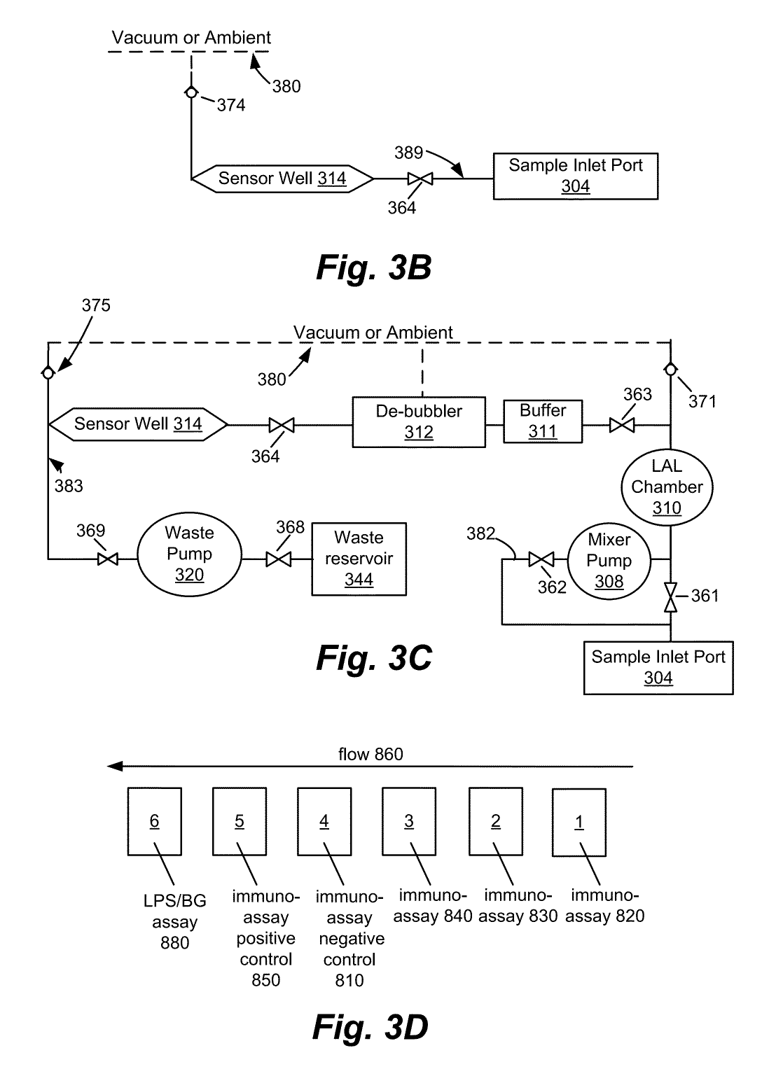

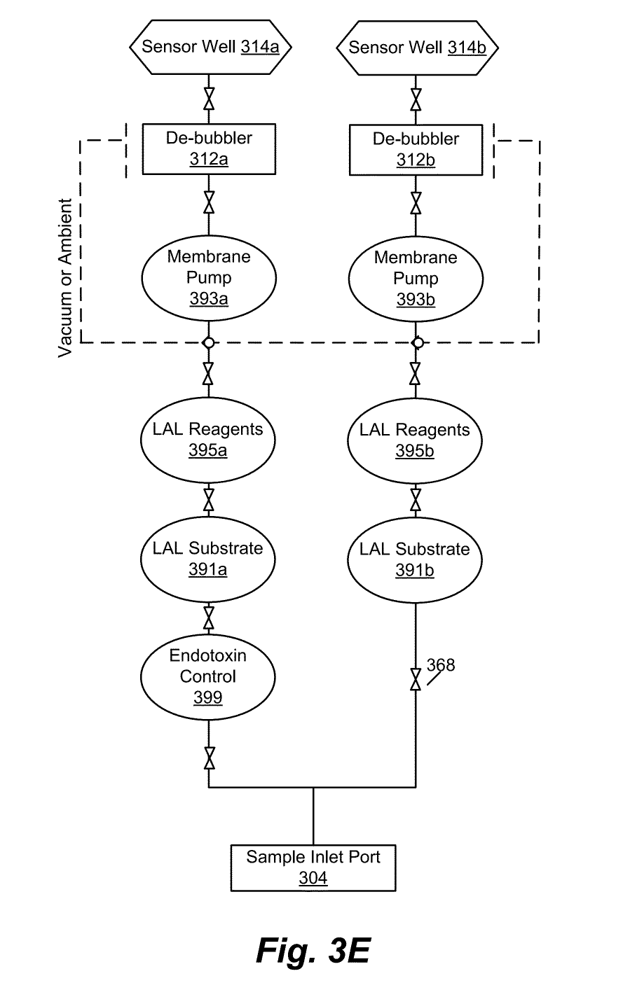

FIG. 3A provides a process flow diagram for operations performed in accordance with disclosed embodiments. In FIG. 3A, an electrochemical LAL assay uses a sample according to certain implementations. After receiving the sample, all of the operations in FIG. 3A may be performed on-cartridge, with a reader controlling all on-cartridge operations.

First, a cartridge including a sample is received in the cartridge (block 301). Prior to block 301, a sample may be transferred to the cartridge via a sample inlet port. In some embodiments, more than one sample inlet port is used to test more than one sample. In some embodiments, a single cartridge may test multiple samples in independent sensor wells. In some embodiments, one sample inlet port is used, but the sample is further divided into more than one conduit in the cartridge to test the assay in replicate. In some embodiments, more than one sample inlet port is used and the samples are divided into more than one conduit in the cartridge to test multiple samples in replicate.

In some implementations, a transfer device and/or an on-cartridge port or compartment that receives the sample is sized to obtain a specified quantity of the sample. The user turns the reader on and inserts the cartridge into the reader. The reader can be configured to automatically turn on when a cartridge is inserted. In some implementations, the reader may identify the type of assay the cartridge is designed for and ask the user to confirm that this is the desired assay. For example, the reader may identify detecting BG only, or LPS only, or both. Further descriptions on detecting BG only, or LPS only, or both, are described below with respect to Tables I, II, and III. In certain implementations in which the reader is designed to work with different types of cartridges and/or samples, the reader may further identify the type of cartridge and/or sample and ask the user for confirmation. One or more target species to be assayed may be present in the sample. Pneumatics may draw the sample through the cartridge. In some embodiments, the sample flows passively.

The sample mixes with the LAL reagents and substrate stored on-cartridge (block 303). LAL reagents include all or some of the components of the lysate itself, including Factor C, Factor B, proclotting enzyme, and in some embodiments, Factor G. In some embodiments, LAL reagents may include inhibitors to detect only LPS or only BG. In some embodiments, some of the LAL components may be removed to detect only LPS or only BG. In some embodiments, some recombinant Factor C may be used to detect only LPS. In various embodiments, the sample may be separated into one or more channels for detection. In some embodiments, the sample mixes with LAL reagents in a reagent chamber. In some embodiments, the sample mixes with LAL reagents before mixing with the LAL substrate. In some embodiments, the sample mixes with the LAL substrate before mixing with the LAL reagents. In some embodiments, the sample mixes with the LAL reagents and substrate simultaneously. The sample is moved to the sensor well (also referred to as a sensor channel, detection channel, or sensor chamber) (block 303). Bubbles may be optionally removed from the sample (block 305). In some embodiments, bubbles are removed using a debubbler.

The sample is then incubated on one or more sensors in the sensor well (block 307). In some embodiments, block 303 and 307 are performed together such that the LAL reagents and LAL substrate are both in the sensor well, and the sample mixes with the reagents and substrate in the sensor well. During incubation, free mediators may be detected by the sensors. In certain implementations, electrochemical sensors including nanostructured electrodes are provided. For example, carbon nanotube (CNT)-based electrochemical sensors can include, for example, networks of CNT's as high surface area working electrodes and can provide highly sensitive detection. In some embodiments, graphene-based electrochemical sensors are used. Electrochemical sensors may also include gold, platinum, palladium, or carbon electrodes. In some implementations, nanostructured electrodes allow a relatively small amount of sample and reagents to be used for multiple sensors, facilitating on-cartridge reagent storage and portable readers and point-of-use systems.

Potential free mediators cleaved from the LAL substrate by the LAL enzymes of the cascade may produce one or more amplified signals. (block 309). Electrochemical reduction of the free mediator generates a current in proportion to the amount of LPS or BG present such that an amplified signal indicates the amount of LPS or BG present. The reader measures the electronic signal(s), and after confirming controls, displays the results of the assay (block 311). The reader can convert the electronic signal to LPS or BG units for display.

In some embodiments, the LAL activation assay cartridge may also include one or multiple immunoassays into a single cartridge with the LAL activation assay(s) (single or dual version). LAL activation assay(s) for detection of LPS and/or BG may be combined onto single cartridge with the immunoassay channel in several ways as described below.

In some embodiments, the LAL reagents and substrates may be included into a dried substance stored in, for example, an LAL chamber, for incorporation as a homogenous mixture.

The released substrate could be detected during immunoassay incubation at a fixed time. This method allows for one LAL assay (per dried LAL chamber or well). An example of such an embodiment is shown in FIG. 3B. FIG. 3B includes a sample inlet port 304, connected to a sensor well 314. The sensor well may be heated as appropriate for the particular assay(s) performed during incubation and sensing using a heater. In various embodiments, the sensor well is heated to a temperature between about 36° C. and about 45° C., or between about 36° C. and about 38° C. In some embodiments, a process in the cartridge that is heated to a temperature up to about 45° C. may have an increased enzyme reaction rate. In some embodiments, the sensor well is heated to a temperature between about 36° C. and about 38° C. for some specific applications. Fluid stop 374 is connected to a vacuum or ambient line. Valve 364 and fluid stop 374 may be used to control flow in the cartridge. In some embodiments of FIG. 3B, the LAL reagents and substrates are immobilized in fluid conduit 389. In some embodiments, the LAL reagents and substrates are immobilized in the sensor well 314. In disclosed embodiments, LAL reagents and substrates may be stored in lyophilized beads, immobilized layers of channels, chambers, conduits, or the sensor well, or a glass matrix with dried material. In some embodiments, lyophilized beads are stored in the sensor well 314, or in another chamber or channel of the cartridge. In some embodiments, immobilized LAL reagents and/or substrates may be immobilized in a chamber or channel, in the sensor well, or in fluid conduits. In some embodiments, LAL reagents and/or substrates in a glass matrix are located in a chamber or channel, or in the sensor well.

FIG. 3C shows an example of a cartridge block diagram for sample filtering, mixing with chemicals in an LAL chamber including LAL reagents and/or substrates, and analysis. While the diagram and the explanation refer to a sample, the block diagram and the process may be applied to other types of samples with appropriate modifications. A sample input port 304, LAL chamber 310, mixer pump 308, buffer zone 311, de-bubbler 312, sensor well 314, waste pump 320, and waste reservoir 344 of cartridge 300 are indicated as well as elastomer valves 361, 362, 363, 364, and 369, and hydrophobic membrane fluidic stops 371 and 375. For clarity, pneumatic lines are not illustration, with the exception of line 380, which can lead to vacuum or ambient as indicated. In some embodiments, a substrate conductivity check (not shown), wash conductivity check (not shown), substrate compartment (not shown), and wash compartments (not shown) are used. For example, where multiplexed assays including both immunoassays and LAL assays are used, such embodiments may include these components. In some embodiments where both immunoassays and LAL assays are processed, a reporter chamber (not shown) may be included in the cartridge.

Fluid may be moved through the cartridge by passive capillary action, or pneumatic actuation via the pneumatic lines such that: 1) vacuum is applied through a hydrophobic barrier layer in the multi-layer microfluidic layer that functions as fluidic stop and 2) on-cartridge diaphragm pumps actuated by applied pressure and/or vacuum. The same reader pneumatic source can be used for opening and closing diaphragm valves, operating the on-cartridge pumps, de-bubbling, moving fluid to the fluidic stop, and operating bag rupture mechanisms. This permits only a small portion of the cartridge to be inserted and interact with reader. A bag rupture process is used in embodiments where an immunoassay is performed, such as when a cartridge performs both an immunoassay and an LAL assay. In some embodiments, liquid movement may be integrated in the reader.

In use, a sample may be introduced to sample inlet port 304. This can be a set volume determined by a sample collection container with the amount determined by the amount of sample desired in the sensor well. In one example, 100-150 μL of whole blood (for clinical applications) is introduced as a sample. The cartridge is then put into a reader, which in some implementations closes all valves as part of an initiation procedure. The reader may identify the card with the user confirming the type of cartridge and assays. No further user input or attention may be used in some implementations, with the assays performed automatically by the reader.

The sample may flow to the LAL chamber 310. In some implementations, the LAL chamber 310 is assumed to be filled after a programmed amount of time is elapsed, e.g., 2-5 minutes. In some other implementations, a feedback mechanism may be employed to confirm the LAL chamber 310 is completely filled. Note that if there LAL chamber 310 is not filled, e.g., because the user did not add enough sample to the cartridge, one or more mechanisms may be employed to detect an insufficient sample.

In some implementations (not shown), valve 362 can be connected to ambient. However if the valve is not airtight, some small amount of air may be pulled into the sample when the vacuum is applied during the filtration process. This may be a very small amount, e.g., on the order of ten or a hundred nL/min. In some implementations, however, the valve is made airtight by providing a liquid in the channel 382. The liquid prevents air from entering the channel 382 through the valve 362, providing an airtight seal.

The LAL chamber 310 contains dried or lyophilized substance, e.g., LAL reagents and/or substrates, and other components of a lyophilized LAL pellet. In some embodiments, the LAL substrates are later added from a substrate compartment. In some embodiments, the LAL substrates are stored in the sensor well 314. Some LAL reagents may include proteins and enzymes, as well as some inhibitors. In some embodiments the LAL reagents include a Factor C inhibitor. In some embodiments, the LAL reagents include a Factor G inhibitor. The LAL substrates used in a cartridge as described herein may be any of those described above with respect to FIGS. 2A-2R. These dried or lyophilized components dissolve in the sample. In some embodiments, valve 361 is closed, the vacuum turned off, and valve 363 is opened. The displacement chamber of mixer pump 308 is opened and closed to pump the sample back and forth over the LAL chamber 310. As the sample is pumped, air may be introduced to the sample from line 380 (now at ambient), with the sample volume increasing as the sample froths. In the example depicted in FIG. 3C, there is a buffer zone 311, which may be a long channel.

Valves 362 and 364 are then opened and a vacuum is applied to line 380 to move the sample into the sensor well 314. Opening valve 362 allows air from the channel 382 to fill from the backend, allowing the liquid in an optional de-bubbler 312 to move into the sensor well 314. Most of the liquid is in the sensor well itself, with a small amount of liquid in the channel 383. Once the liquid is in the sensor well, a check for bubbles may then be optionally performed.

According to various implementations, the time from insertion to results may be about 10 to about 30 minutes and can be 10-15 minutes or even faster depending on if and how long the sample is incubated. The sensor well may be heated as appropriate for the particular assay(s) performed during sensing. In various embodiments, the sensor well is heated to a temperature between about 36° C. and about 38° C. Heating can occur by any appropriate method, with an example of heaters according to certain implementations described below with respect to FIG. 7.

In some embodiments, more than one sensor well and more than one LAL chamber 310 may be used. In various embodiments, dual detection of LPS and BG may be performed in a cartridge as described herein. In some embodiments, a single sensor well may include more than one electrode for detection. At least one electrode may be for performing an LAL assay, while at least another electrode may be used for performing an immunoassay. For example, FIG. 3D provides an example of arrangements of electrodes in a sensor well for assays and controls according to various implementations. A control can be located furthest along a flow path, such as positive control 850 being located furthest along the flow path 860 through the sensor well, though in some other implementations a positive control may be located at the beginning or in the middle of a flow path either in addition to or instead of at the end of the flow path. According to various implementations, a single cartridge for a point-of-use electrochemical sensor may be configured for one or more LAL assays, enzymatic assays, and immunoassays. In some implementations, the sample may incubate over the electrodes in a sensor well while the LPS/BG assay 880 is performed to detect presence of LPS or BG. The sensor well may be washed to then perform the immunoassays in 820, 830, and 840, as well as the positive control 850 and negative control 810 for the immunoassay. That is, in some embodiments, the sample incubates in the sensor well for a period of time, e.g., 5 minutes, prior to wash fluid being pumped to the sensor well to wash an immunoassay reporter out.

In some implementations, this can include placing a LPS/BG sensor at the end (furthest along the flow path) of a sensor channel. An example is shown in FIG. 3D, in which the LPS/BG assay sensor 880 is the last sensor (sensor 6) and so has the least amount of liquid initially flowing by as the sensor well fills. Moreover, in some implementations, the available volume past the LPS/BG sensor is reduced or eliminated.

In some implementations, one or more enzymes and/or mediators may be provided as a solid phase reagent and mixed with the sample prior to delivery to the sensor well, rather than being coated on the working electrode. In some embodiments, the LAL substrate may be included into a dried substance at the LAL chamber 310 for incorporation as a homogenous mixture and the LAL reagent(s) could be incorporated onto pads within the sensor well 314. In various embodiments, the LAL substrate and the LAL reagent(s) could be incorporated onto pads within the sensor well 314. In some embodiments, the LAL substrate is incorporated in the dried report and the LAL reagents are immobilized in fluid conduits connecting the LAL chamber 310 to the sensor well 314. In some embodiments, a side-fill into another reaction chamber or chambers may be used. Filling to alternate reactions chamber(s) could be performed at the end of the immunoassay channel, before the immunoassay channel, or through a separate sample addition port on the cartridge. In some embodiments, the LAL substrate and the LAL reagent(s) could be provided into separate vials or containers where they are rehydrated and mixed with samples off-cartridge and then added via separate ports.

FIG. 3E provides another schematic block diagram depicting a sample mixing with LAL reagents and a substrate to detect presence of LPS or BG. A sample is inserted to the cartridge at sample inlet port 304, which may then split into two fluid conduits. In some embodiments, more than two fluid conduits may be present for a single sample inlet port 304. In some embodiments, more than one sample inlet port 304 may be used. Note that FIG. 3E shows various valves 368 that may be used to control fluid movement. Fluid may be moved by capillary action, vacuum, or pneumatic valves.

An endotoxin control channel 399 may be used to as a way to detect any LPS contamination. In some embodiments, a BG control channel is used instead. The control channel may be used such that the control is released to the LAL substrates in 391a, and the LAL reagents in 395a, which may ultimately be detected in the sensor well 314a to determine if there is any existing endotoxin contamination in the system. This may also be used to calibrate the cartridge. In some embodiments, an optional membrane pump 393a may be used to mix LAL reagents with the LAL substrate and the endotoxin control. In some embodiments, a debubbler 312a may be optionally used to remove bubbles from the liquid before the liquid enters the sensor well 314a. In some embodiments, the debubbler is connected to vacuum or ambient.

In a separate fluid conduit, the sample may mix with LAL substrates at 391b, and with LAL reagents at 395b. The LAL substrates in 391a and 391b may be any of those described above with respect to FIGS. 2A-2R. In some embodiments, the membrane pump 393b is used to mix the sample with the LAL reagents 395b and LAL substrates 391b. The fluid may be optionally debubbled at debubbler 312b, prior to delivery to the sensor well 314b for detection.

To perform dual detection, various types of LAL reagents may be used. For example, to detect BG only, an LAL reagent void for Factor C, such as those with a Factor C inhibitor, may be used. This reagent is only reactive with BG and does not respond to LPS contamination.

To detect LPS only, an LAL reagent with a Factor G inhibitor may be used. Since multiple sample input ports may be used, with corresponding individual sensor wells and optional LAL channels, cartridges described herein may detect both LPS and BG in a single sample. Tables I, II, and III provide schemes for detecting LPS, BG, and both LPS and BG using standard LAL reagents, Factor G only LAL reagents, and Factor C only reagents. In some embodiments, detection of LPS only involves using recombinant Factor C, as described above with respect to FIG. 1B.

In Tables I, II, and III, the “+” symbol represents a positive reading, where the sample is detected. A “−” symbol represents a negative reading, where the sample would not be detected. A “++” symbol represents a positive reading that may be amplified, such that the sample is detected. For example, in Table I, a standard LAL reagent will give a positive reading for a sample with LPS, or a sample with BG, or a sample with both LPS and BG. The “++” symbol represents the effect of both LPS and BG initiating the cascade and generating a positive reading. In the Factor G only LAL, LPS is not detectable (thus a “−” symbol is represented) because the LAL reagents only trigger the Factor G cascade for BG, and Factor C would not be triggered for the LPS LAL cascade.

TABLE I
Dual Detection Schemes for Standard LAL and Factor G Only LAL

| | Standard | Factor G |
|---|---|---|
| Target Substrate | LAL | Only LAL |
| LPS | + | − |
| BG | + | + |
| Both LPS and BG | ++ | + |

TABLE II
Dual Detection Schemes for Standard LAL and Factor C Only LAL

| | Standard | Factor C |
|---|---|---|
| Target Substrate | LAL | Only LAL |
| LPS | + | + |
| BG | + | − |
| Both LPS and BG | ++ | + |

TABLE III
Dual Detection Schemes for Factor C Only LAL and Factor G Only LAL

| | Factor C | Factor G |
|---|---|---|
| Target Substrate | Only LAL | Only LAL |
| LPS | + | − |
| BG | − | + |
| Both LPS and BG | + | + |

The methods and substrates described herein may be performed in a cartridge and corresponding reader. Further description of a cartridge and reader system for amperometric detection is described in U.S. patent application Ser. No. 13/844,434, filed on Mar. 15, 2013, titled “POINT OF CARE SENSOR SYSTEMS,” which is herein incorporated by reference in its entirety.

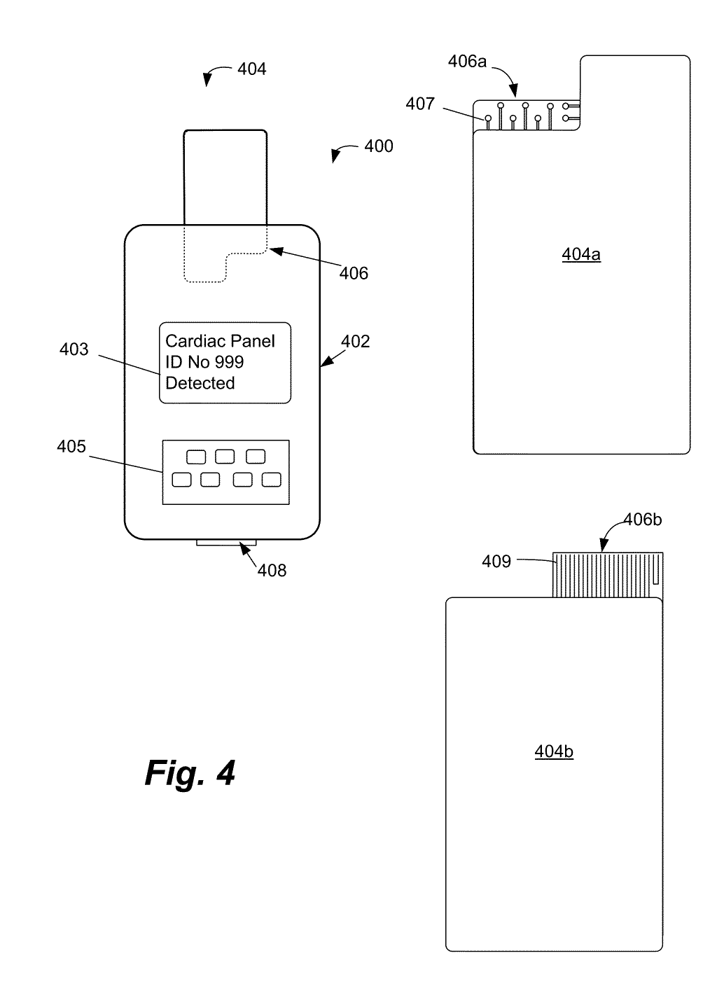

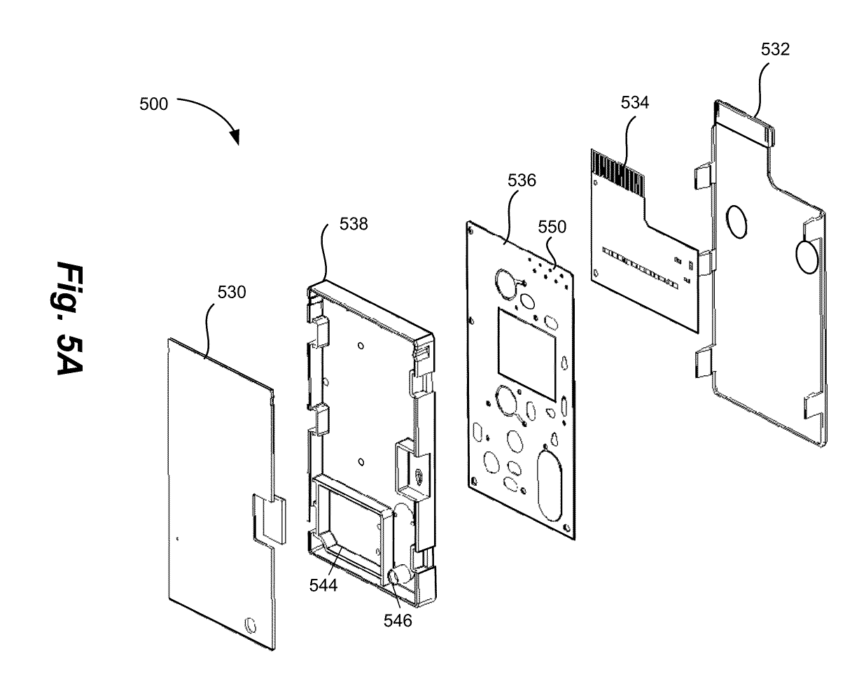

FIG. 4 is a simplified schematic showing an example of a point-of care system 400, including a reader 402 and a cartridge 404 inserted in the reader 402. In use, the liquid sample to be analyzed is placed in the cartridge 404, with the cartridge 404 then placed in the reader 402. In some implementations, the sample and other fluids are moved through the cartridge by application of capillary action, pressure, and/or vacuum. This can eliminate the use of mechanical solenoids and other complex non-pneumatic actuators. As a result, the reader 402 may be configured to interface with only a small portion 406 of the cartridge 404, for example to provide an electrical interface to sensor electrodes and vacuum, capillary, and/or pressure lines to move fluids and open/close valves. As described further below, the sample can be mixed with LAL reagents and LAL substrates as described herein and delivered to one or more electrochemical sensors for analysis. Signals from the electrochemical sensors can be read and stored by the reader 402. In some implementations, the systems can be used to perform enzymatic LAL assay that detect substances in a liquid sample.

The reader 402 may include a pneumatic system including one or more pumps to provide vacuum and pressure to the cartridge and software and hardware to control the assay and read the results. These components can be housed within a sturdy, impact resistant polymer casing. The reader 402 may further include an interface 408 to connect to a computer system. User interface features of the reader 402 can include a display 403 and keyboard 405. In some implementations, the reader can be configured to handheld, e.g., with a single hand of an operator. In some implementations, the reader may include a handle portion configured for easy handling during operation. Example masses of the reader 402 can be around 500 g-1200 g, e.g. 900 g. Example volumes of the reader can be around 1000 cm²-2500 cm², with dimensions on the order 5 cm-25 cm. In one example, a reader can be around 18 cm×13 cm×5 cm.

FIG. 4 also shows examples of interface portions 406a and 406b of first and second sides 404a and 404b of cartridge 404. First side 404a includes interface portion 406a, which includes pneumatic ports 407 configured to connect to pneumatic lines in the reader 402 and provide vacuum, pressure and/or ambient to the cartridge 404. In the example of FIG. 4, eight ports 407 are depicted, though fewer or more may be used according to the particular implementation.

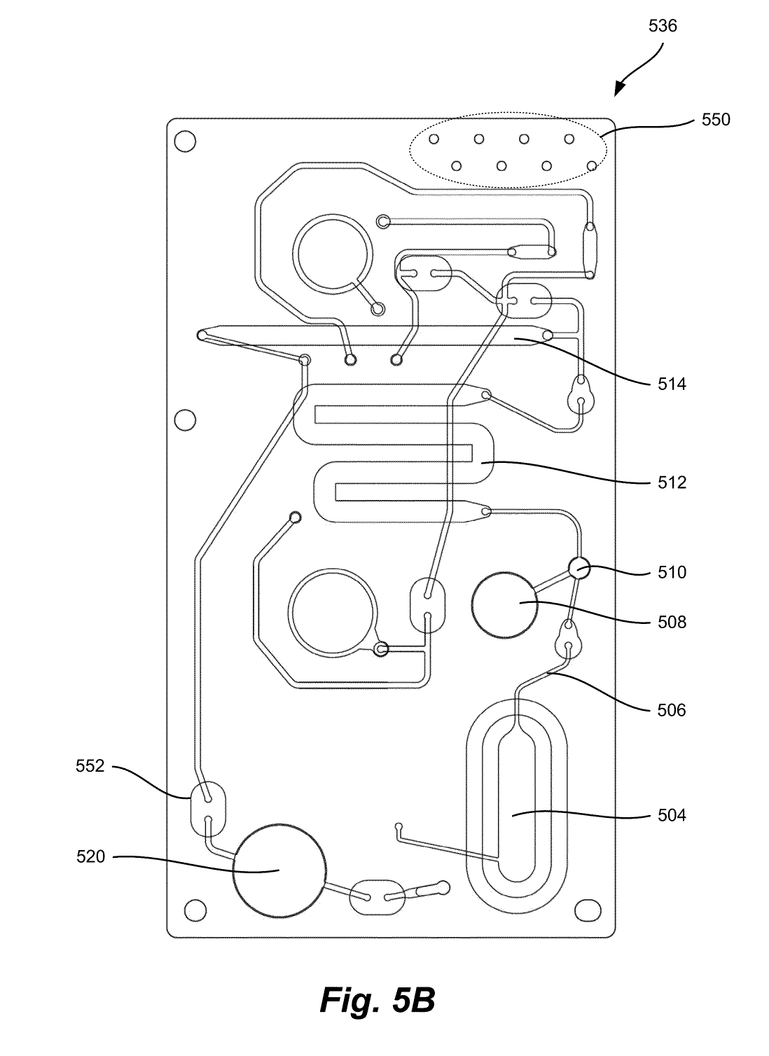

FIG. 5A is a schematic representation of a cartridge 500, in accordance with certain implementations. Components of cartridge 500 include top and bottom plates 530 and 532, respectively, sensor assembly 534, microfluidic layer 536, and airline plate 538. The components may be arranged in a plastic body including top plate 530, bottom plate 532, and airline plate 538, which may be formed from multiple different parts assembled together. Each part may be individually molded during fabrication of cartridge 500 followed by assembly of these parts. The components of cartridge 500 may be formed during these molding operations and/or assembly operations. The plastic body may be any thermally stable, chemically inert plastic. Some of the components of the cartridge 500 may be made from materials that are different than plastic body 502.

Cartridge 500 of FIG. 5A may be a single-use cartridge, with the sensors and cartridge materials disposable after use. In certain implementations, some of the reagents are provided in the reader. For examples, the substrate and reagents may be stored in refillable or replaceable containers in the reader. While this approach simplifies the construction of the cartridge and lowers cartridge costs, it increases the complexity of reader operation and design.

The cartridge 500 may further include a microfluidic layer 536, which may include pneumatic channels and microvalves and microfluidic channels and chambers. The microfluidic layer is discussed further below with respect to FIGS. 5A and 5B, as well as in U.S. patent application Ser. No. 13/844,434, filed on Mar. 15, 2013, titled “POINT OF CARE SENSOR SYSTEMS,” which is herein incorporated by reference in its entirety. Airline plate 538 provides connections (not shown) from pneumatic ports 550 to pneumatic channels on the microfluidic layer 536. Airline plate 538 may include a sample inlet port 546 and a waste chamber 544. In some embodiments, microfluidic layer 536 includes passive channels, such as capillaries, suitable for capillary movement of fluids through the cartridge.

FIG. 5B is an example of a schematic representation of micro-fluidic layer 536. It shows various compartments, channels, valves, and other components of microfluidic layer 536. The microfluidic layer 536 is a multilayer microfluidic layer 536, with various components arranged in multiple different levels. Accordingly channels and other components that overlap in FIG. 5B are in different layers and may not intersect or have fluid communication with each other.

A sample chamber 504 may be connected to sample line 506 that pulls or passively flows the sample from the sample inlet port 504 and into other components of cartridge 500. From sample line 506, the sample flows into a LAL chamber 510. LAL chamber 510 may include one or more LAL reagents and/or LAL substrates for mixing with the sample. In some embodiments, these reagents or substrates may be provided in a lyophilized form and may be preinstalled in cartridge 500. Examples of substrates include substrates with a mediator as described above with respect to FIGS. 2A-2R. In some embodiments, LAL chamber 510 may be connected to an optional mixer 508 and an optional de-bubbling channel 512. De-bubbling channel 512 separates gases from liquid in the sample by passing the sample over one or more hydrophobic membranes that transfers gas but not fluids. The LAL chamber 510 and mixer 508 are part of a mixing circuit that allows flowing sample solution through LAL chamber 510 in both directions, which may be used for dissolving lyophilized pellets provided in LAL chamber 510. In some implementations, the dimensions of the mixing circuit are sufficient to allow the fluid to fold over during mixing. In some implementations, the system mixes the reagents sufficiently with the sample to provide precise quantities of a free mediator to the sensor well without the using sonication, vortexing, or other methods used to dissolve reagents and substrates.

Multiple cycles of sending a sample along a fluid conduit, such as between LAL chambers and the sensor well, or between LAL chambers and the mixer 508 repeatedly washes the sample over the LAL chamber 510, providing good mixing to be sent to the sensor channel 514. The mixer 508 can include a fluidic chamber and a pneumatic displacement chamber separated by an elastomer membrane. Actuation of mixer 508 by application of vacuum and/or pressure to the pneumatic displacement chamber can pump the sample in and out of the fluidic chamber during mixing.

Microfluidic layer 536 also includes a sensor channel 514, which aligns with one or more electrochemical sensors of a sensing assembly 534 of FIG. 5A for sensing various components of a sample. Various features of sensor assemblies and corresponding channels are described below with reference to FIG. 7. In certain implementations, sensor channel 514 is in proximity with a heater to maintain a certain predetermined temperature of various components in sensor channel 514, such as a sample and probes.

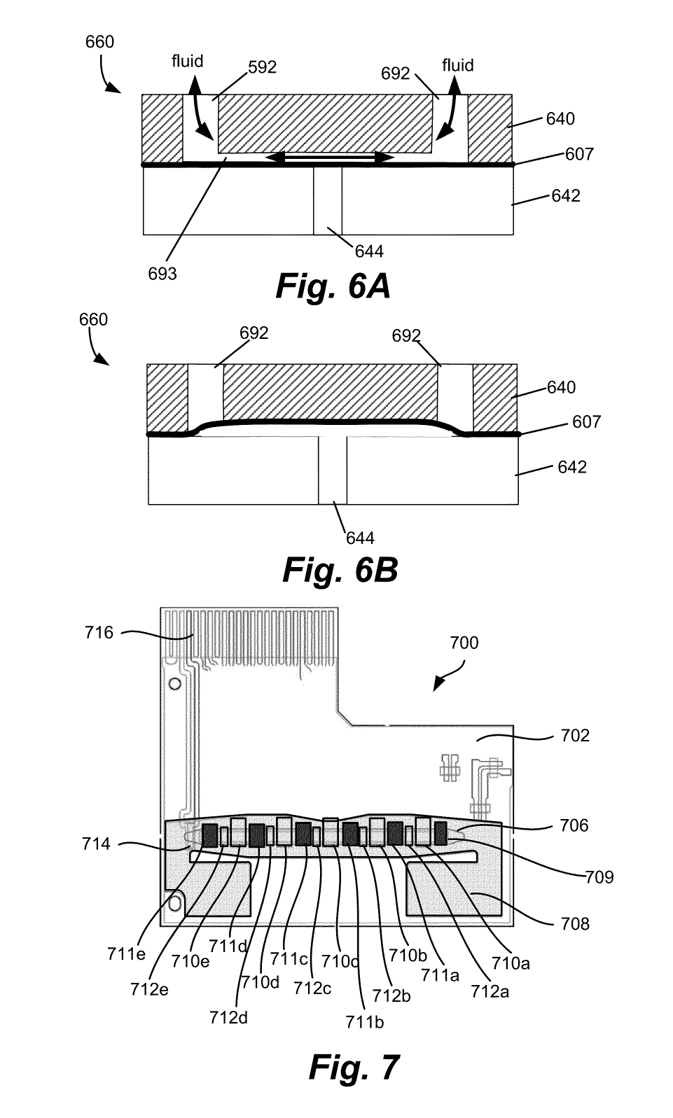

Liquid communication between different channels and/or comportments of cartridge may be adjusted by operation of valves, such as pneumatically actuated diaphragm valves. For example, one of the diaphragm valves in FIG. 6B is indicated at 552. Diaphragm valves may include an elastomeric membrane separating fluidic channels from pneumatic channels or ports. Application of pressure and/or vacuum may be used to actuate the valve opening and/or closing. According to various implementations, each valve may be closed or open in its unactuated state, as appropriate. Examples of diaphragm valves that may be used are described below with reference to FIGS. 6A and 6B. Vents to ambient may also be included. In some implementations, fluid may be pumped by pneumatic displacement chambers separated from a fluidic chamber. For example, mixer 508 and waste pump 520 in FIG. 5B may be used to pump sample and waste, respectively. In the example of FIG. 5B, eight pneumatic inputs from a reader are indicated at 550, though any appropriate number may be used. In some implementations, the total number of valves and displacement chambers may be less than the number of pneumatic inputs, with a single input controlling multiple valves and/or displacement chambers, reducing size and power requirements of the reader.

FIGS. 6A and 6B provide one example of a diaphragm valve that may be used in accordance with various implementations. FIG. 6A depicts diaphragm valve 660 open, which can allow bi-directional fluid flow as depicted. Diaphragm valve includes membrane 607, and fluid-side and pneumatic-side layers 640 and 642. (Each of layers 640 and 642 may be composed of one or more layers or the microfluidic layer.) Fluid-side layer 640 includes vias 692 and fluidic channel 693 and pneumatic layer 642 includes pneumatic port 644. Vacuum and/or pressure from the reader can be applied to the valve 660 via pneumatic lines within the cartridge to deflect the membrane 607 to open and close the valve 660. FIG. 6B shows the valve 660 in a closed position.

In some implementations, pressure/vacuum is applied throughout use to actively control and prevent fluid movement. This allows the device to be handheld during use without it being rested on a flat, stable surface. Active control of the liquid movement may prevent the liquid from undesired sloshing, movement, etc. when the reader and cartridge are moved. This can also be useful if the device is used in transit, for example, if detection is performed while in a moving automobile, such that liquid remains isolated in the detection channel.

FIG. 7 is a schematic illustration of a sensing assembly 700 that may be used in accordance with certain implementations. Sensing assembly 700 is an example of a sensing assembly 534 incorporated into a cartridge 500 as shown in the example of FIG. 5A. Sensing assembly 700 may be formed on a base sheet 702 by screen printing various components. Base sheet 702 may be made from a polyester-containing material or other appropriate chemically inert material. In certain implementations, the thickness of base sheet 702 is between about 3 mil and 15 mils, for example, about 7 mils.

Components of sensing assembly 700 on base sheet 702 can include working electrodes 710a-710e, counter electrodes 711a-711e, reference electrodes 712a-712e, thermocouple 714, and heater 708. Conductive lines, some of which are not shown in FIG. 7 for clarity, extend from each electrode to the top 716 of the sensing assembly 700 for electrical connection to the reader. Each pair of working and counter electrodes 710a and 712a, 710b and 712b, 710c and 712c, 710d and 712d, 710e and 712e forms an electrochemical cell and may be used for a different assay. Reference electrodes 711a-711e may or may not be present according to the desired implementation. In some implementations, a single reference electrode may be used in turns for multiple working electrodes. Also, in some implementations, if separate reference electrodes are used, the signals from reference electrodes 711a-711e may be tied together on the cartridge or in the reader. For example, the voltages from multiple parallel reference electrodes may be averaged. In some embodiments, certain electrodes may be used in a sensor well to detect LPS, while other electrodes are used in a separate sensor well to detect BG.

The electrodes are at least partially in sensor well region 706, which may be in a microfluidic channel or face a microfluidic channel. Such a microfluidic channel can be defined by, for example, one or more layers of a microfluidic layers as described above with reference to FIG. 5B. All electrochemical cells are exposed to the same continuous liquid film in a microfluidic channel that is or can be open at either end of the sensor well region. Any number of independent electrochemical cells may be present according to the desired implementation.

Because the heater is separated from the sensor well only by a thin base, heating the liquid in the sensor well is very efficient. In addition, because a screen printed heater have very small mass, it takes very little energy to generate sufficient heat. For example, the heater may be a 0.5 Watt or 1 Watt heater and can heat a sensor well up to 100° C. The thermal efficiency is particularly advantageous for battery-powered point-of-use applications where size and weight requirements place constraints on available battery capacity. The heater may be coupled and controlled by a thermocouple to provide more precise temperature. In various embodiments, the heater is used at a temperature between about 36° C. and about 45° C., between about 36° C. and about 38° C., or about 37° C. In some embodiments, the heater is used at a temperature up to about 45° C. may have an increased enzyme reaction rate. Heater fabrication may include certain blends of inks to achieve a specific electrical resistance of the heater for a given area. The heater may be fabricated by screen printing, photolithography, sputtering, or ink jet methods.

In multiplexed electrochemical assays, the electrodes can be arranged in any appropriate fashion. In some implementations, the electrodes are arranged along the length of the channel, with the reference electrodes 712a-712e located adjacent the working electrodes 710a-710e. Counter electrodes 711a-711e, along with electrode 709 can be spaced such they provide a uniform electrical field along the length of the sensor well region 706. In some implementations, multiple electrochemical cells can share a counter electrode. This reduces the number of electrodes and leads used for multiplexed assays. In some embodiments, eight sensor wells are used for multiplexed electrochemical LAL assays.

### EXPERIMENTAL

### Experiment 1

### Bound Vs. Free 4-Amino-4′Methoxydiphenylamine

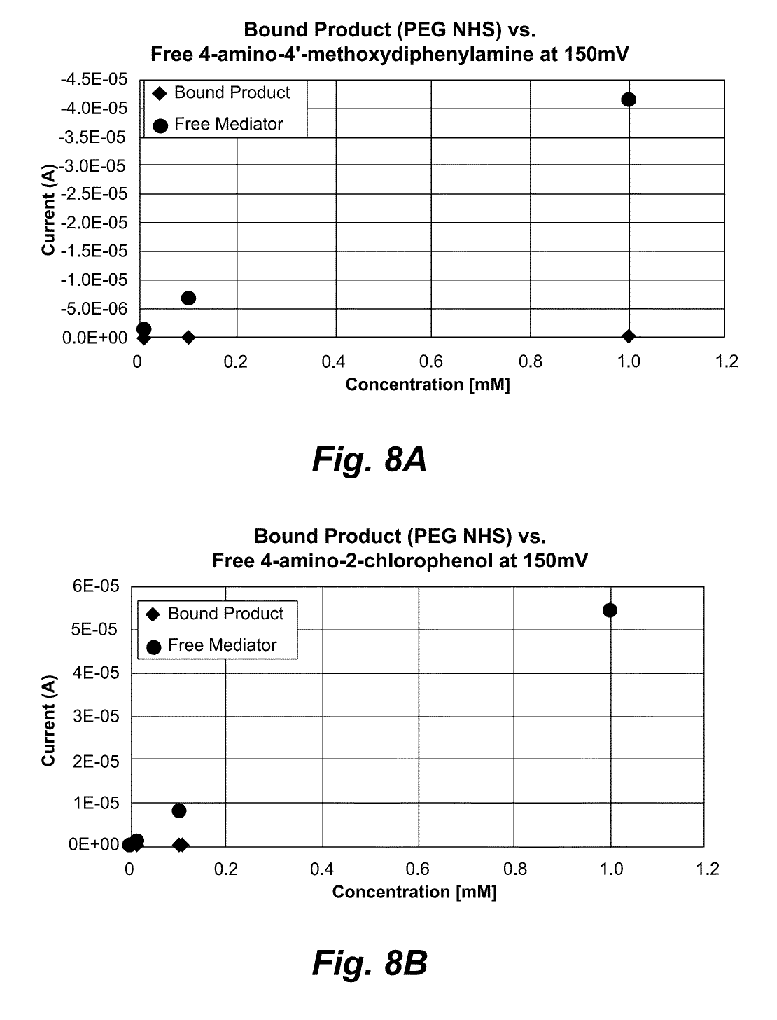

Amperometric detection of the bound product versus free mediator is conducted by holding a potential constant while the current is measured. A mediator 4-amino-4′-methoxydiphenylamine (p-amino-p-methoxydiphenylamine) is incubated with excess amine-reactive N-hydroxylsuccinimide (NHS) ester-functionalized homobifunctional polyethylene glycol (PEG) to form an amide bond through the free amine of the mediator. The difference in amperometric signal generated from the free mediator (circle) and amidated, or bound, mediator (diamond) is illustrated in FIG. 8A. The diamonds represent current for the bound product, and the circles represent current for the free mediator. As shown, the free mediator is distinguished from the bound product to determine whether the clotting enzyme is present (and thus whether LPS or BG is present). Here, the bound product does not exhibit a signal, whereas the free mediator does.

### Experiment 2

### Bound Vs. Free 4-Amino-2-Chlorophenol

Amperometric detection of the bound product versus free mediator is conducted by holding a potential constant while the current is measured. A mediator 4-amino-2-chlorophenol is incubated with excess amine-reactive NHS-Ester-functionalized homobifunctional polyethylene glycol (PEG) to form an amide bond through the free amine of the mediator. The difference in amperometric signal generated from the free mediator (circle) and amidated, or bound, mediator (diamond) is illustrated in FIG. 8B. The diamonds represent current for the bound product, and the circles represent current for the free mediator. The free mediator is distinguished from the bound product to determine whether the clotting enzyme is present (and thus whether LPS or BG is present). Here, the bound product does not exhibit a signal, whereas the free mediator does

### Experiment 3

### Full Range of Mediator Detection

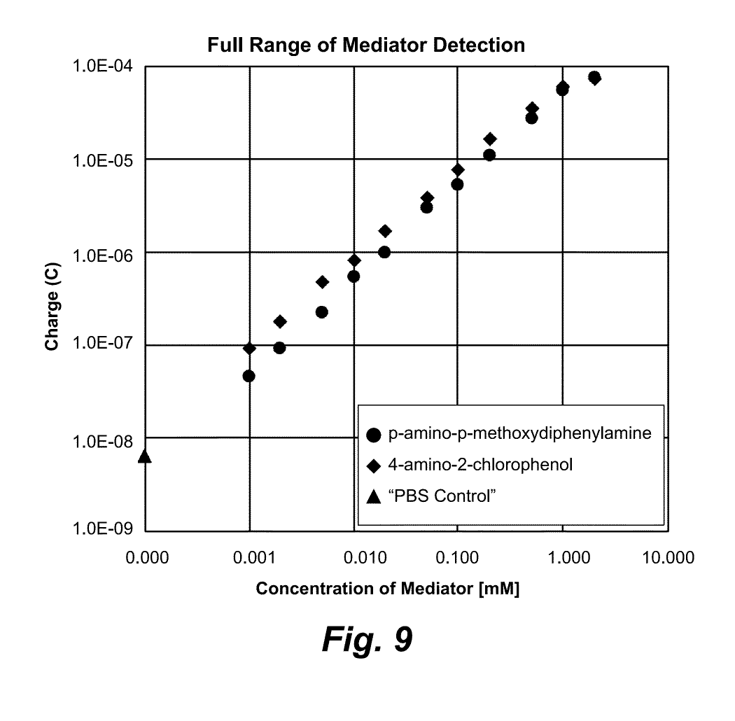

The full range of mediator detection was evaluated for p-amino-p-methoxydiphenylamine (circles) and 4-amino-2-chlorophenol (diamonds). The amperometric ranges of detection are evaluated from a concentration of 0.001 mM to 4 mM. The results showed a range of concentrations for which these mediators exhibit a charge, as shown in FIG. 9. The results indicate that these two mediators are suitable for use in substrates to exhibit a detectable amperometric signal.

### Experiment 4

### BG Detection by P-Aminophenol Mediator

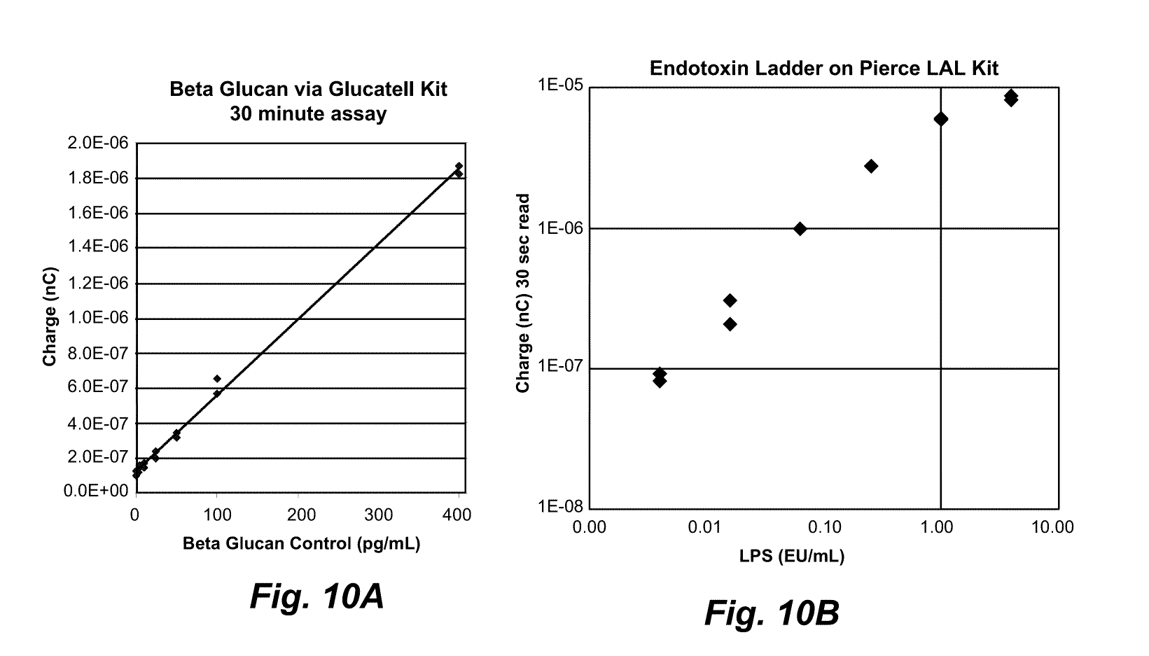

FIG. 10A shows the amperometric response of a p-aminophenol mediator labeled substrate used in conjunction with Glucatell™ reagents, which are only activated through the Factor G (beta-glucan specific) Limulus Amebocyte Lysate clotting pathway. Glucatell™ LAL reagents, which are available from Associates of Cape Code, Inc., of Falmouth, Mass., are premixed with a chromogenic substrate that competes with the electrogenic substrate in this case. In this experiment, a 30-minute assay was used to detect 1-3-β-D-glucan. BG was measured in picograms per milliliter, and charge was measured in nanocoulombs.

### Experiment 5

### LPS Detection by P-Aminophenol Mediator

FIG. 10B shows the amperometric response of a p-aminophenol-mediator-labeled substrate used in conjunction with Limulus Amebocyte Lysate reagents (Pierce LAL Chromogenic Quantitation Kit, available from Thermo Fisher Scientific Inc. of Rockford, Ill.). No chromogenic substrate was added to the LAL lysate reagent in this case. LPS was measured in endotoxin units per milliliter. The charge was measured in nanocoulombs.

### CONCLUSION

Although the foregoing embodiments have been described in some detail for purposes of clarity of understanding, it will be apparent that certain changes and modifications may be practiced within the scope of the appended claims. It should be noted that there are many alternative ways of implementing the processes, systems, devices, and apparatus of the present embodiments. Accordingly, the present embodiments are to be considered as illustrative and not restrictive, and the embodiments are not to be limited to the details given herein.

What is claimed is:

1. An electrochemical substrate for detecting endotoxins and/or 1-3-β-D-glucan, the substrate comprising:
a peptide, and
an electrochemical group selected from one of the following structures: 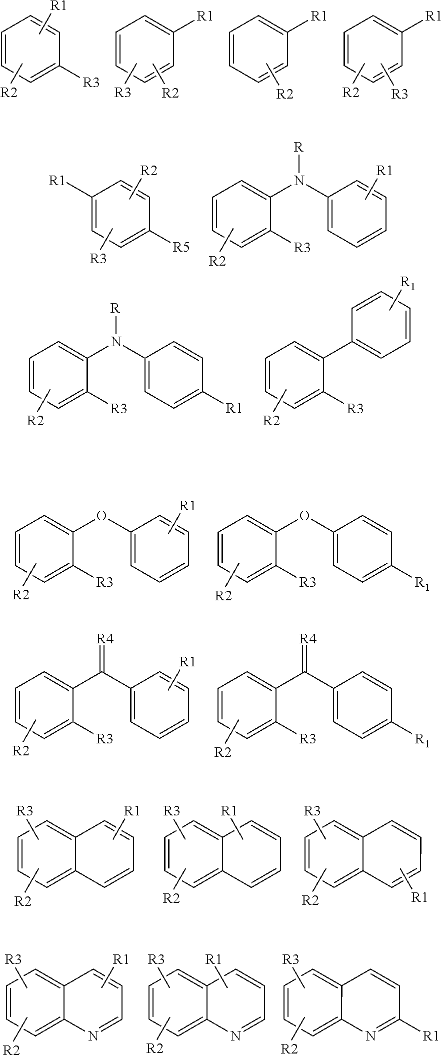
wherein
R1 is a primary amine, or a secondary amine,
R2 is a hydroxyl, a methoxy, an ether, a ketone, an aldehyde, or a carboxylic acid,
R3 is a hydrogen, halide, or hydroxyl,
R4 is a hydrogen or hydrocarbon chain
R is a hydrogen or hydrocarbon chain, and
R5 is a methoxy, an ether, a ketone, an aldehyde, or a carboxylic acid.

2. The substrate of claim 1, wherein the R1 is capable of conjugating to a C-terminus of the peptide.

3. The substrate of claim 1, wherein the substrate is reactive to an activated clotting enzyme of limulus amebocyte lysate.

4. The substrate of claim 1, wherein the substrate has one or more detectable oxidation or reduction peaks between about −300 mV to about 300 mV.

5. The substrate of claim 1, wherein the peptide comprises a sequence A1-A2-Aₙ, where n is an integer greater than or equal to 3.

6. The substrate of claim 5, wherein the amino acid residues are bonded to the electrochemical group via the C-terminus of Aₙ.

7. The substrate of claim 5, wherein Aₙ is arginine.

8. A cartridge for sensing one or more analytes in a sample, the cartridge comprising:
one or more sample inlet chambers;
one or more electrochemical sensors;
one or more solid phase limulus amebocyte lysate detection reagents; and
one or more detection channels providing a flow path over the one or more electrochemical sensors.

9. The cartridge of claim 8, further comprising a heater configured to heat the one or more detection channels.

10. The cartridge of claim 9, wherein the heater is formed by a technique selected from the group consisting of screen-printing, photolithography, sputtering, and ink jet.

11. The cartridge of claim 8, further comprising a reagent chamber configured to store the one or more solid phase limulus amebocyte lysate detection reagents.

12. The cartridge of claim 11, further comprising a mixing circuit connected to the one or more sample inlet chambers and comprising a mixing chamber and the reagent chamber.

13. The cartridge of claim 12, further comprising a microfluidic layer, the microfluidic layer comprising the reagent chamber, the mixing chamber, and the one or more detection channels.

14. The cartridge of claim 8, further comprising a de-bubbling channel disposed upstream of the one or more detection channels and configured to vent out bubbles in the sample.

15. The cartridge of claim 8, wherein the cartridge includes at least two electrochemical sensors and is configured to detect endotoxins and beta-glucans from a single sample.

16. The cartridge of claim 8, further comprising a thermocouple.

17. The cartridge of claim 8, further comprising a plurality of fluid stops connected to a hydrophobic membrane.

18. The cartridge of claim 8, wherein all liquid movement within the cartridge is pneumatically actuated.

19. The cartridge of claim 8, wherein liquid in the cartridge is moved by capillary action.

20. The cartridge of claim 8, further comprising pneumatically actuated valves for controlling fluid movement in the cartridge.

21. The cartridge of claim 8, further comprising an immunoassay detection chamber.
